(19) United States
(12) Patent Application Publication
(10) Pub. No.: US 2019/0278383 A1
(43) Pub. Date: Sep. 12, 2019

(54) ACCESSIBLE INPUT DEVICE AND METHOD

(71) Applicant: Alternate Devices, LLC, Harleysville, PA (US)

(72) Inventor: Derek John Yerger, Philadelphia, PA (US)

(73) Assignee: Alternate Devices, LLC, Harleysville, PA (US)

(21) Appl. No.: 16/298,692

(22) Filed: Mar. 11, 2019

Related U.S. Application Data
(60) Provisional application No. 62/641,307, filed on Mar. 10, 2018.
(60) Provisional application No. 62/681,870, filed on Jun. 7, 2018.

(51) Int. Cl. G06F 3/02; G06F 3/023; G06F 3/03

(52) U.S. Cl. CPC G06F 3/0227; G06F 3/03; G06F 3/023

(57) ABSTRACT

Disclosed herein is a system for processing sensor inputs collecting movement inputs from a user, and translating the interpreted data into actions entered into a computer. The system and method is used to process sensor inputs from a mounted electronic pressure sensor which transfers pressure input from a user's feet to the sensor. The system and method incorporates a microcontroller for reading the sensor, and microcontroller firmware code implementing the system and method described herein. After the system and method identifies a distinct and recognized input applied to perform a desired action in the computing device, such as an input that includes a distinct pressure and duration of application, a sequence of keystrokes and/or pattern of mouse inputs may be determined and entered into the computing device. These keystrokes and/or pattern of mouse inputs may be designed to perform the desired action in the computing device.

### CROSS-REFERENCE TO RELATED APPLICATIONS

This application claims the benefit of U.S. Provisional Application Nos. 62/641,307 filed Mar. 10, 2018 and 62/681,870 filed Jun. 7, 2018, which are incorporated by reference as if fully set forth.

### FIELD OF INVENTION

The present invention is directed to technology prevalent in today's society including interactive user devices, and is designed to bridge the gap in accessibility for people with disabilities who are often unable to use this technology in a traditional manner.

### BACKGROUND

Many illnesses cause issues affecting upper extremities. Amputations, movement disorders and illnesses inhibit the ability for individuals to interact with a computer, via a keyboard and mouse, for example, or other interactive medium, such as video games, touch-screen devices, and the like, for example. Therefore these illnesses, in addition to the other effects of the illnesses are also accompanied by a loss of ability that hampers interaction with others.

In addition, for patients that rehabilitate from these illnesses or other types of illnesses, their occupational therapists often employ tools to assist patients in regain these lost abilities. A hurdle in rehabilitating patients with severe disabling conditions is in providing interactive activities which empower patients to overcome obstacles and do things for themselves. Activities that are interactive increase the recovery speed of a patient as compared to passive activities, such as watching television.

Computers have become a life-blood of our society and a way for people to interact with people from all walks of life a beyond the room in which they are located. Computers also offer a variety of functions, including communication, learning, and entertainment. In typical use, a computer is operated using a keyboard and/or mouse, permitting a user to provide a set of inputs to perform a variety of actions. Many computers rely on touch input, such as tablets and smart phones, for example. In many cases the “typical use” is not available to individuals for reasons presented above. As such, a need exists to provide alternative systems and methods to increase access to these devices for individuals that cannot or will not use them in a typical fashion.

### SUMMARY

Disclosed herein is a system for processing sensor inputs collecting movement inputs from a user, and translating the interpreted data into actions entered into a computer. The system and method is used to process sensor inputs from a mounted electronic pressure sensor which transfers pressure input from a user's feet to the sensor. Other extremities and a user's mouth may also be used to provide input. The system and method incorporates a microcontroller for reading the sensor, and microcontroller firmware code implementing the system and method described herein. After the system and method identifies a distinct and recognized input applied to perform a desired action in the computing device, such as an input that includes a distinct pressure and duration of application, a sequence of keystrokes and/or pattern of mouse inputs may be determined and entered into the computing device. These keystrokes and/or pattern of mouse inputs may be designed to perform the desired action in the computing device.

### BRIEF DESCRIPTION OF THE DRAWINGS

A more detailed understanding can be had from the following description, given by way of example in conjunction with the accompanying drawings wherein:

FIG. 1A illustrates a system for using a computing device that translates inputs from a user input device into inputs to the computing device;

FIG. 1B illustrates a method for use in the system of FIG. 1;

FIG. 2 illustrates the attachment of the input device to a computing device;

FIG. 3 illustrates a cloud-based attachment of the user input device to a computing device;

FIG. 4 illustrates a high-level flow of the system and method of the present invention;

FIG. 5 illustrates the system and method for interpreting pressure and duration in a single sensor;

FIG. 6 illustrates a method for collecting multiple sensor inputs and determining an action to take within the present system;

FIG. 7 illustrates the interpretation of the language for representing key and mouse combinations;

FIG. 8 illustrates a keyboard with specific keys denoted. In an embodiment exemplary of one use case;

FIG. 9 illustrates a plurality of configuration templates that may be utilized in the present system and method;

FIG. 10 illustrates a basic design of an input device;

FIGS. 11 and 12 illustrate an embodiment of an input device;

FIGS. 13 and 14 illustrate an embodiment of the user input device;

FIG. 15 illustrates an alternative configuration for the user input device; and

FIG. 16 is a block diagram of an example device in which one or more features of the disclosure can be implemented.

### DETAILED DESCRIPTION

Disclosed herein is a system for processing sensor inputs collecting movement inputs from a user, and translating the interpreted data into actions entered into a computer. The system and method is used to process sensor inputs from a mounted electronic pressure sensor which transfers pressure input from a user's feet, hands, other extremity, or even mouth, to the sensor. The system and method incorporates a microcontroller for reading the sensor, and microcontroller firmware code implementing the system and method described herein. After the system and method identifies a distinct and recognized input applied to perform a desired action in the computing device, such as an input that includes a distinct pressure and duration of application, a sequence of keystrokes and/or pattern of mouse inputs may be determined and entered into the computing device. These keystrokes and/or pattern of mouse inputs may be designed to perform the desired action in the computing device.

The system and method may process sensor inputs from two or more pressure sensors, each of which transferring pressure inputs from a user's feet to the sensor. The system and method incorporated a microcontroller to read the sensor, and microcontroller firmware code to implement the system and method described herein. After the system and method identifies the sensor data such as by combining the processed data of each sensor into positional data to differentiate individual inputs as distinct and recognizable inputs, a sequence of keystrokes and/or pattern of mouse inputs may be determined and entered into the computing device. These keystrokes and/or pattern of mouse inputs may be designed to perform the desired action in the device.

The system and method may be used to process sensor inputs from an inertial measurement unit. Such an inertial measurement unit may include one or more electronic accelerometers, one or more gyroscopes, and one or more magnetometers, each capable of producing orientation data. The system and method may be embodied in microcontroller firmware which detects a pattern of motion input including tilt direction, magnitude, and duration, and duration deviated from a home position. Such input patterns may have been previously identified as corresponding to an action. Upon receipt of the detected input pattern, a pattern of keystrokes and/or mouse inputs is entered into the computing device to cause the computing device to perform a desired action.

The present system and method also include programming or learning that may be utilized within the present device. This programming may be incorporated with the other disclosures described herein and may allow a professional, such as an occupational therapist or other user, to configure the device to perform a multitude of desired actions based on received inputs. The system and method is capable of being programmed by an end user, occupational therapist, or other intermediary to assist a patient or end user in performing a desired set of tasks. Programming is performed through an easy-to-use web page accessible by connecting a laptop, phone, or tablet to a standard Wi-Fi access point provided by the device for management. Alternatively, the device may connect to the internet through a standard Wi-Fi connection and may be managed through a web page stored on a central a computer.

The system and method allows differently-abled users to be able to control digital devices, such as computing devices including computers, tablets, and phones, for example, to interact with common applications to perform tasks, such as browsing web pages, using educational software, and playing games, for example. The input device utilized in the system and method may be foot-operated or be designed to be used in any capacity allowing for touch inputs.

The input device may include two pressure sensors held in a bar-like enclosure coupled to the system that interprets a variety of touch-based gestures on the input device. The touch-based gestures may be differentiated by location on the input device, duration, and pressure level and interpret the gestures to provide sequences of keystrokes and/or mouse inputs to cause actions to be performed on a connected computing device. This input system emulates a keyboard and is compatible with any device that recognizes USB Human Interface Devices (HID), such as a PC, Mac, or Android tablet or smartphone.

This solution addresses the need to provide those affected by loss of function with the means to start doing things on their own, restoring hope and empowering the patent to engage in interactive activities. The system and method allows those with severe disabilities to have a degree of independence in performing many activities, helping them along the road to recovery and onward in daily use.

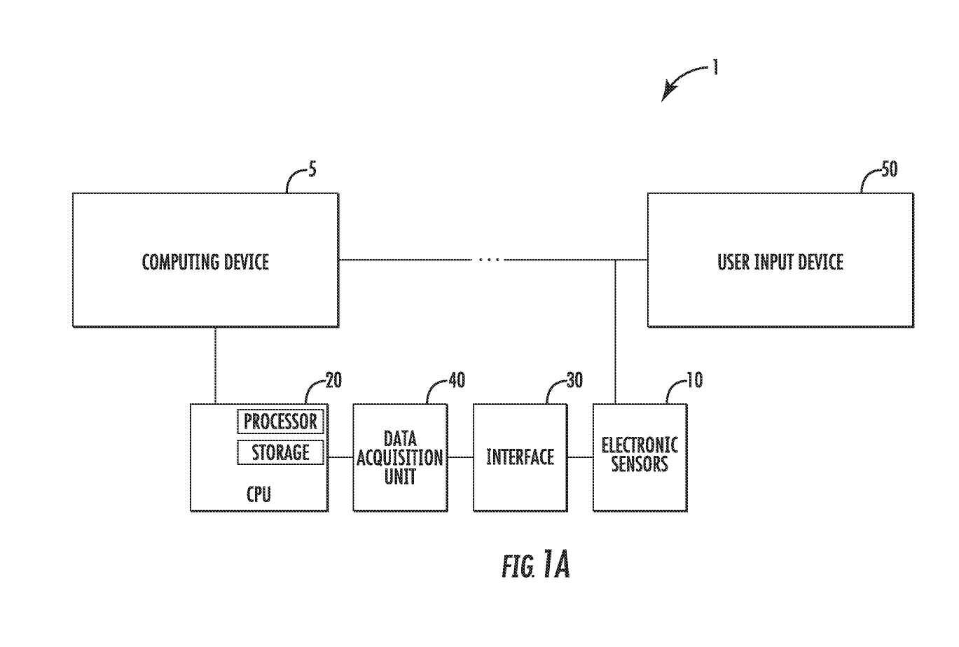

FIG. 1A illustrates a system 1 for using a computing device 5 that translates inputs from a user input device 50 into inputs to the computing device 5. System 1 includes one or more electronic sensors 10 for detecting inputs from a user, a central processing unit 20 including an interface 30, a data acquisition unit 40 or system coupled to the central processing unit 20.

Data acquisition unit 40 is configured to collect data from the one or more electronic sensors 10. Interface 30 is configured to transmit keyboard or mouse input signals to an attached computer. The processed input signals may be translated into key presses, mouse movement, and/or mouse presses to perform a desired action on the computing device 5. Electronic sensors 10 may provide a plurality of inputs such as level of pressure or angle of tilt. Central processing unit 20 may store software or firmware in a storage device 22 that when processed on a processor 24 performs the functions of the system 1. Data acquisition unit 40 collects analog signals from electronic sensors 10 and converts them to discrete digital values. Sensor inputs are processed in a manner that distinguishes discrete user inputs into an interpretable signal. The interpretable signal includes at least one of duration of input, amount of pressure, location of pressure, angle of tilt and angular velocity. Interface 30 is either Universal Serial Bus or Bluetooth. Processed inputs may be temporally combined and interpreted as a single input from a user. A user-provided sequence of keyboard or mouse inputs is transmitted to an attached computing device 5. Desired actions are defined by a user.

FIG. 1B illustrates a method 80 for use in the system 1. Method 80 includes detecting an input from a user at step 82, collecting data from the detected input at step 84, translating the collected data into input signals to perform desired computing device action at step 86, and transmitting input signals to an attached computing device at step 88.

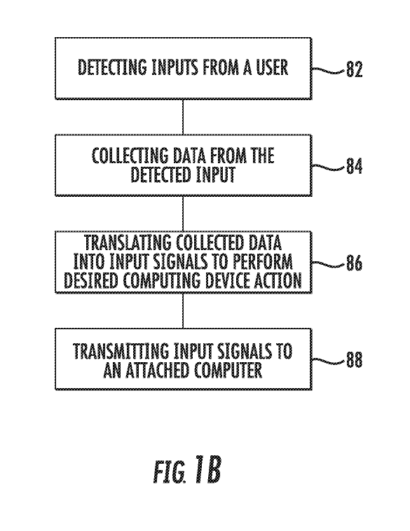

FIG. 2 illustrates a wired attachment of the user input device 50 to a computing device 5. As shown the computing unit 5 is a laptop computer 6. The input device 50 is hardwired via a USB connection 51. Other wired configurations may also be utilized. In addition, as will be understood, wireless connections may also be used. Some wireless connections include Bluetooth, ZigBee, and the like.

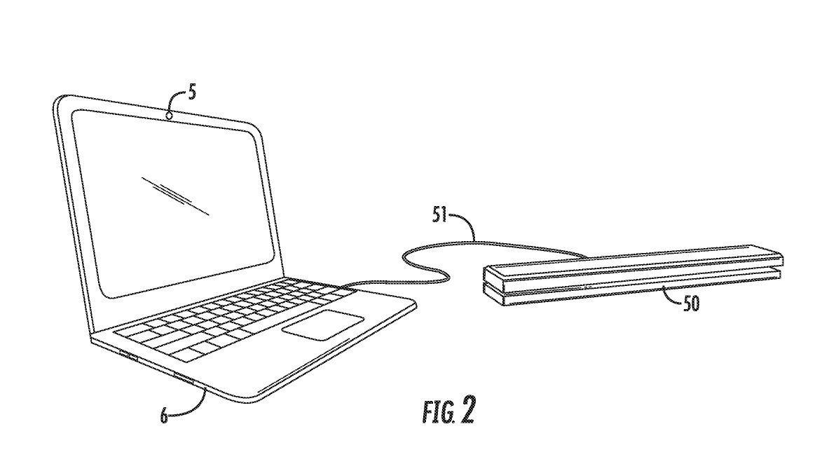

FIG. 3 illustrates a cloud-based attachment 1.1 of the user input device 50 to a computing device (not shown). In attachment 1.1, user input device 50 may include electronic sensors 10 and a Wi-Fi relay 15. Wi-Fi Relay 15 operates to communicate over the Internet to cloud-hosted management. This connection may operate using TLS-protected data. This enables the device to operate using a “cloud” architecture. Such a configuration may allow physical devices to include less processing and memory, for example. The network may terminate at the cloud software platform. This allows for termination and management of a multitude of services and devices, service portal created for end users, and medical providers, and allows access by medical providers to treatment plans for users involving use of the hardware devices, and track completion of user completion of goals.

The method may provide a way to program the device through a web browser, including such web server held locally inside the device, and separately with the web server in the cloud with the device containing a transceiver.

The device may be configured by a user as described below. In such a situation, user input may be received and translated into device programming. The method may include a user interface in the form of a computer application, web page, serial interface, or other interactive media.

In one such embodiment, a web server, capable of serving interactive web content (such client-side technologies include HTML, CSS, JavaScript) through HTTP, provides an interface for the user to choose templates, or adjust individual inputs to perform user-defined actions. This web server is contained within the computer inside the invention.

The invention provides access through WiFi, Bluetooth, Ethernet, or other networking technology, whereby a user, using a standard computer, connects directly to the input device.

In another embodiment, the web server is hosted on a remote server on the internet. A user, using a standard computer with internet connection, accesses a publicly-available configuration platform, whereby one or more devices locally or remotely connect to the server for communication of status and programming.

The transport may include TCP, TLS, UDP, DTLS, HTTP(S), WebSockets, or the like. The server tracks a multitude of devices, allowing the user to configure them individually or as a set.

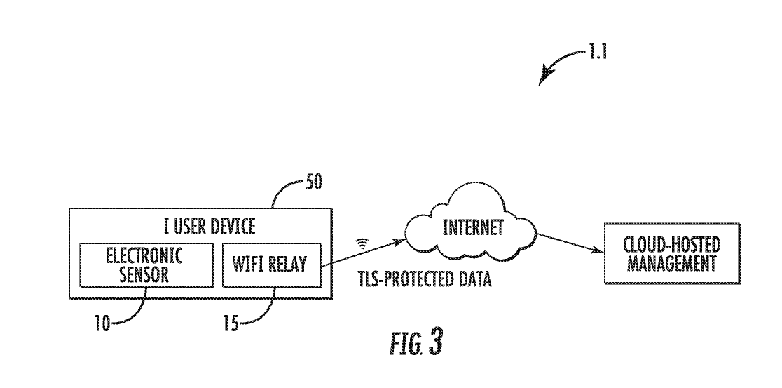

FIG. 4 illustrates a high-level flow of the system and method of the present invention. In method 400 shown, a single pressure sensor is read at step 402. The pressure sensor may be one or electronic sensors 10. Pressure sensing may collectively be referred to as step 405.

The pressure sensing 405 includes, from the read value it is determined whether the pressure applied exceeds one of two predetermined thresholds—the hard press at step 404 and the soft press at step 406. If the pressure exceeds the threshold constituting a hard press at step 408, and a hard press has not been recorded, the system notes the new maximum pressure reached as being a hard press at step 410. If the pressure exceeds the threshold constituting a soft press at step 412 and a hard press has not been detected, the system notes the new maximum pressure reached as being a soft press at step 414.

While performing the pressure sensing activity of the system at step 405, a separate sub-process records the time at which any pressure threshold was exceeded in duration sensing of step 415. While the pressure threshold constituting a soft press is exceeded, if the duration since start of pressure detection exceeds a predetermined duration at step 416, the pressure is noted as being a press-and-hold action at step 418. This permits the system to distinguish between a tap, such as a short duration press, or a press-and-hold, such as a long duration press.

After a specific pressure level and duration has been determined by the system 1, the method 400 determines whether specific user-provided programming dictates an action to take for that given input (press from 405 and duration from 415) at step 420. If programming exists at step 422, a sequence of keystrokes is sent at step 424 to the attached computer to perform the action described by the program.

As shown in FIG. 1A, the method includes a sensor value is read at step 402. In the pressure sensing portion 405 of FIG. 1A, the sensor value that is read is analyzed to determine if the value is greater than a hard press at step 404, and if not is the value greater than a soft press at step 406. If the value is greater than a hard press at step 404, it is determined if the sensed value is less than hard press at step 408. If it is not, then the stored pressure is set equal to hard press value at step 410. If the sensed value is greater than the hard press, then duration sensing may occur at step 415.

If the value is greater than a soft press at step 406, it is determined if the sensed value is less than a soft press at step 412. If it is not, the stored pressure is set equal to the soft press value at step 414. If the value is greater than a soft press, then duration sensing may occur at step 415.

In the situation where the value is less than a hard press and less than a soft press, user programming may be checked to determine is the given pressure and hold pressure exists at step 420 and is defined at step 422. If programming is defined then a keyboard or mouse input may be determined at step 424. Otherwise the value may be reset at step 426 and the process restarted.

In the duration sensing 415, it is determined if the time since the last press is greater than a long press at step 416. If it is, then the hold pressure is set equal to the pressure at step 418. If it is not, then the process may be delayed at step 428 and started anew.

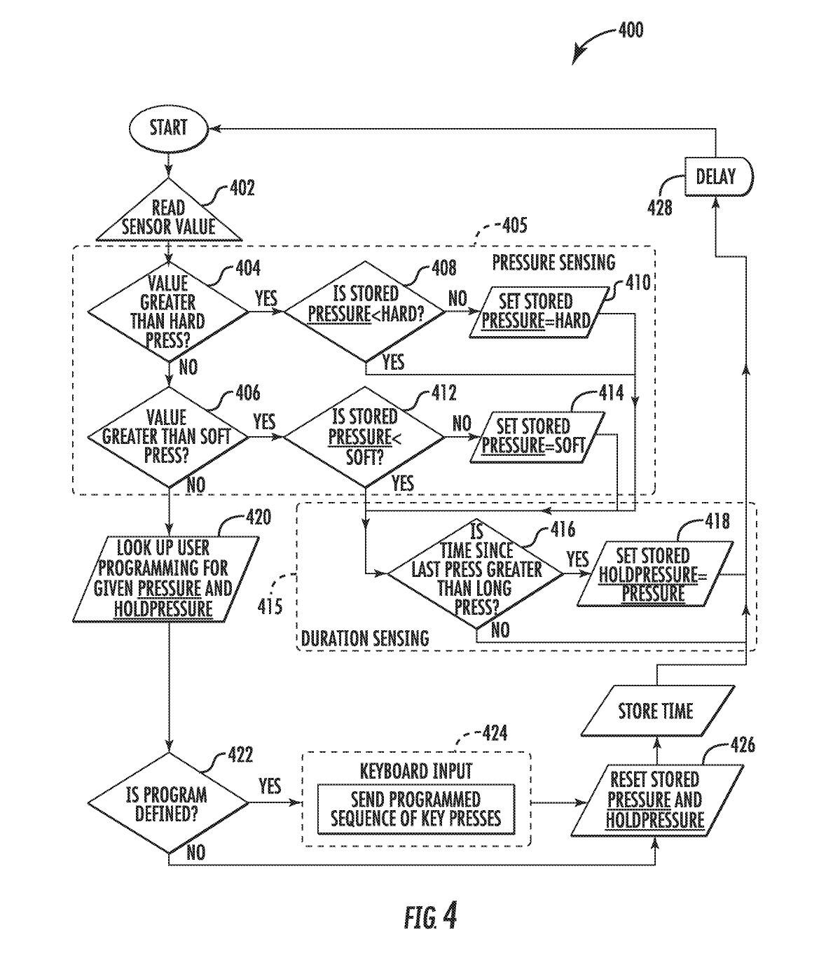

FIG. 5 illustrates method 500 used in system 1 for interpreting pressure and duration in a single sensor. The flow of FIG. 5 may be performed for each sensor being sensed in a multiple sensing system, for example. The start time of a reading, referred to as “lastImpulse,” is tracked, along with the collection representing which sensors had measurable inputs, referred to as “sensorMask,” and the value representing pressure and duration data, referred to as “impulse.” At the onset of pressure detection past a predetermined threshold, the time is noted in the “lastImpulse” variable. The sensor data is individually processed, with any sensor which has received detectable input being added to the collection called “sensorMask”. The detection of a pressure exceeding the hard press threshold or exceeding the duration of a long press is noted in the “impulse” register. A flag for delaying the interpretation of inputs, referred to as “readImpulse,” along with a preset delay may assist in accurate detection of user input.

Specifically, in method 500 the sensor is read and a value sensed is determined at step 502. If the value is greater than a soft press and the last impulse is zero at step 504, the impulse and sensor mask are reset and the value is stored as the last impulse variable in an impulse buffer at step 506.

If the value is less than a soft press at step 504 and the last impulse is zero at step 508, then the value is stored in an impulse buffer at step 510. If the value of soft press and last impulse is zero at step 512, the sensor mask is set to the sensor number at step 514 and the average of the impulse buffer is compared to the hard press variable at step 516. If there is a hard press and the impulse is 1 at step 518, it is determined if the time since the last impulse is a long press at 520. The read impulse time may be set to settle time at step 524.

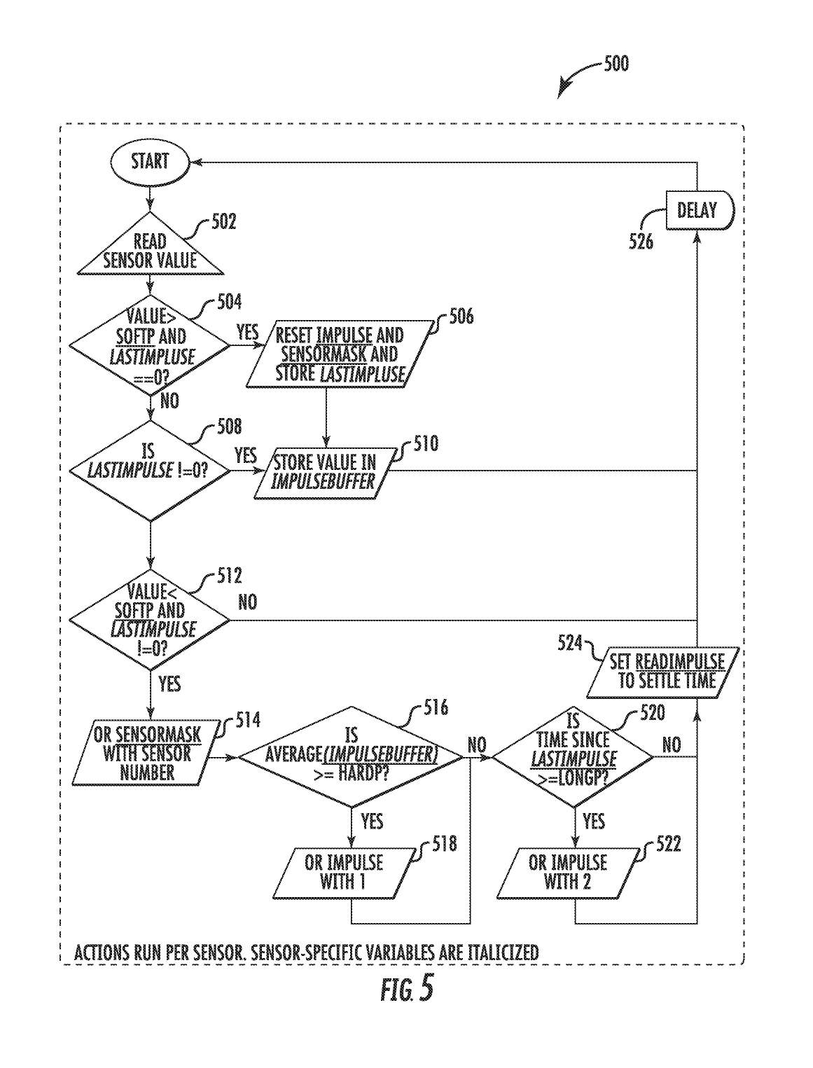

FIG. 6 illustrates a method 600 for collecting multiple sensor inputs and determining an action to take within system 1. After a settle time is reached, where no additional inputs are detected, the after-release actions are taken to interpret the input into a computer action.

The subprocess “fetchImpulse” (not shown) may include retrieving the correct program string for the given combination of sensors, pressure, and duration. This string is loaded into a purpose-built firmware, or, in the case of the some embodiments, is dynamically set by a user of the device using a programming system.

Specifically, as illustrated in FIG. 6, the read impulse is analyzed to determine if greater than or equal to 1 at step 602. If greater than 1, the read impulse is decremented by 1 at step 604 and re-checked at step 606. If the read impulse is 1, then the read impulse is set to zero at step 610 and after-release action is taken 615. After release action 615 may include processing the fetch impulse at step 612, and processing the parse command at step 614, and clearing previous stored values at step 616 once processing is complete. By setting the read impulse value to an arbitrarily high number (or “hold off” time), the decision about the user's intentions may be delayed. If the read impulse is not greater than 1 at step 602 and is not equal to zero at step 606 the processing of read sensors occurs at step 608.

The input device may adjust to a user by modifying system sensitivities. A calibration algorithm may use successive inputs from the user and the respective pressure values, along with duration of contact and resting or idle pressure to set a new value for soft press, hard press, press and hold and or baseline idle pressure. This may be performed using input such as last detected input, consisting of pressure, tilt, or other continuous input, duration of the last detected input, and type of last detected input. The algorithm may output a new soft press threshold, a new hard press threshold, a new long press threshold, and a new zero point.

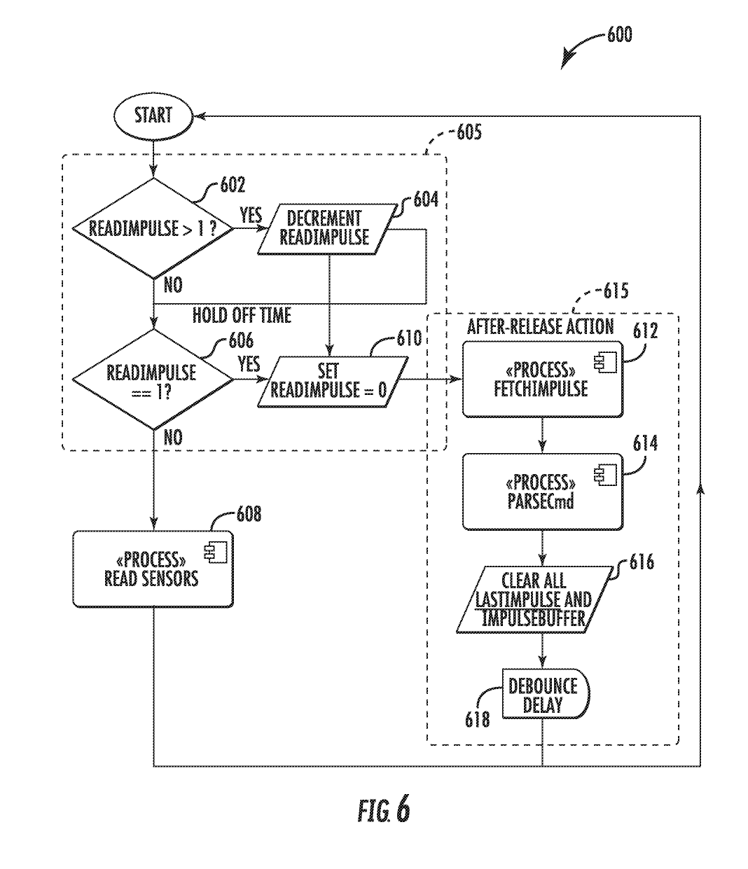

FIG. 7 illustrates a method 700 for the interpretation of the language for representing key and mouse combinations. Depicted in FIG. 7 is the subprocess “parseCmd” that translates a succession of characters into computing device 5 interpretable instructions to thereby represent keystrokes entered into a computer. The use of a language to describe special keys, such as modifiers, is used to aid a user in easily programming the device using a specific building vocabulary.

The flow of FIG. 7 includes determining the next character in a variable hidsequence at step 702. It is then determined is the next character is a special character at step 704, including, but not limited to, \hat{ }, +, %, &, !, ˜, |, for example. If a special key is determined to be present at step 714 then that special key is effectively pressed on the keyboard at step 722. If a special key is not present, then a determination is made if case programming mode is entered at step 706. If the key is ACSII between 65 and 90 at step 708 then 128 is added to the code at step 718 and the keyboard is pressed at step 726. If the character is a semicolon at step 712 then exit occurs. If the next character is a backslash at step 710, then the keyboard is pressed and the next character is started at step 720.

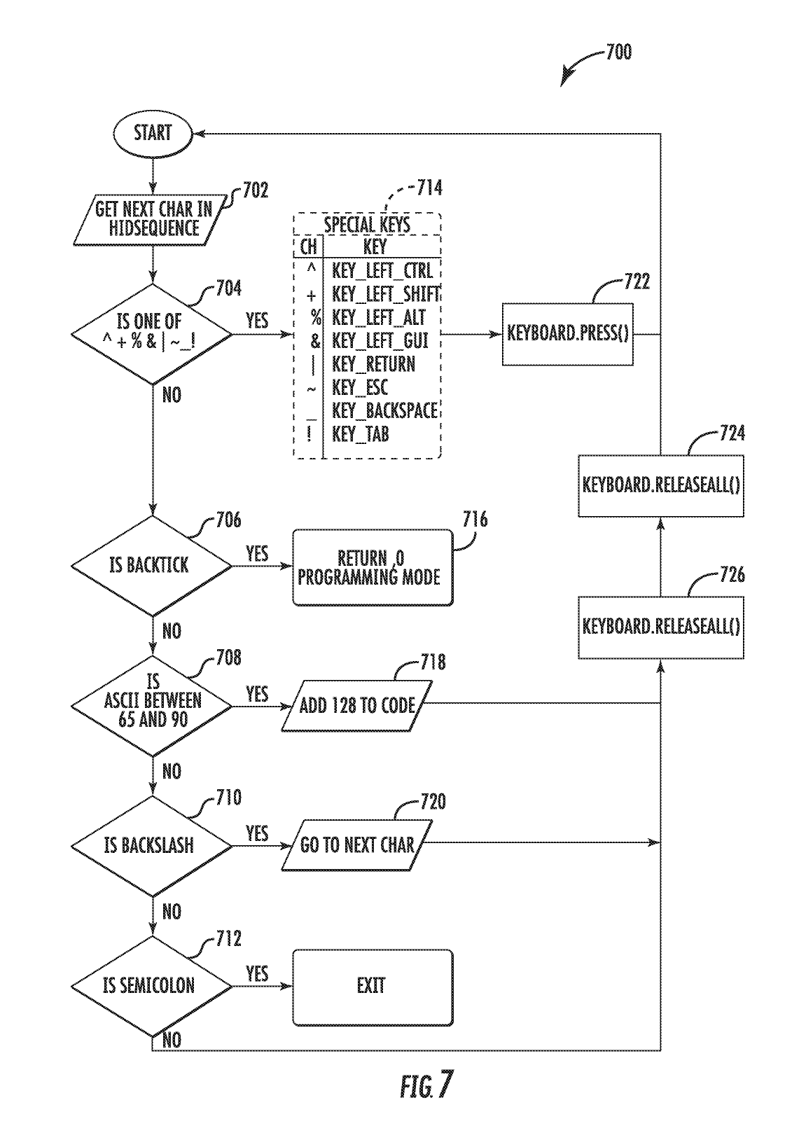

FIG. 8 illustrates a keyboard with specific keys denoted. In an embodiment exemplary of one use case, system 1 and the methods described herein may recognize four distinct inputs and translates the inputs to permit a user to browse a web page. One impulse causes the space bar 802 to be pressed, causing the web browser to scroll down the page. Another impulse causes the tab key 804 to be pressed, causing the web browser to select the next link on the page. A third impulse causes the enter key 806 to be pressed, causing the web browser to navigate to the selected link. A fourth impulse causes the device to hold the Alt key 808 while pressing the left arrow key, causing the web browser to go back to the previous page

By way of example, sample detections and associated actions taken are presented in Table 1.

TABLE 1

| Input Detected | Action Taken | Result |
|---|---|---|
| Soft press | Space bar is pressed | Browser scrolls down webpage |
| Hard press | Tab key is pressed | Browser selects next link |
| Hard press and | Enter key is pressed | Browser navigates to link |
| hold | | |
| Soft press and | Alt key is held, left | Browser navigates to previous |
| hold | arrow key is pressed | page |

The input device may be programmed to allow a sequence of soft, hard, short, long, left, right, or center presses to be assigned to actions commonly used to navigate web pages. The input device may be programmed to assign actions for board games, the office productivity software, VIM in addition to, or alternatively to, web browsing.

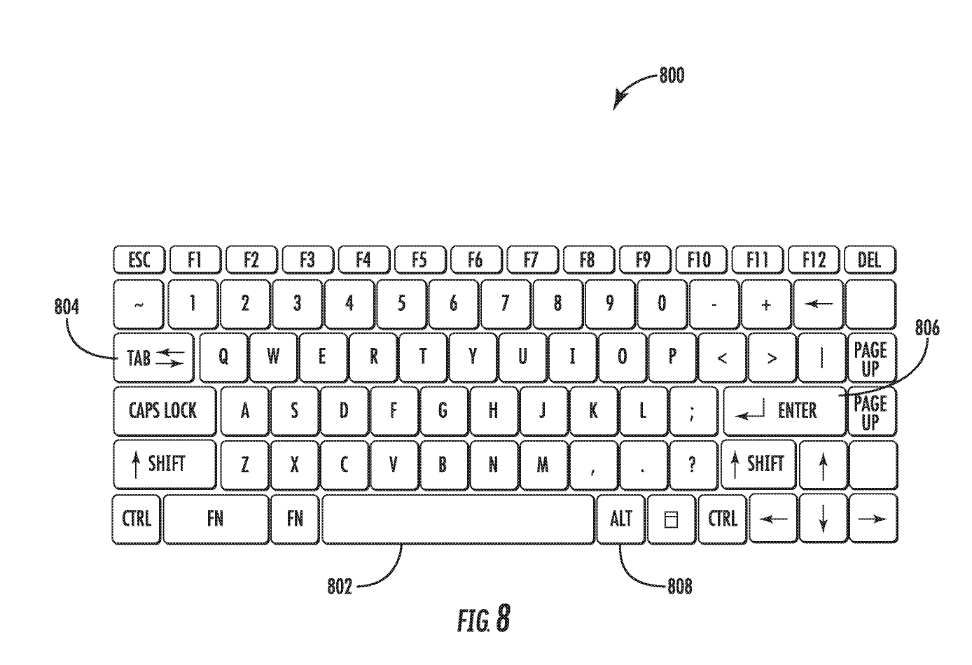

FIG. 9 illustrates a plurality of configuration templates 900 that may be utilized in system 1 and the methods described herein. As shown in FIG. 9, there are several pre-programmed templates for translating inputs to action. For example, a soft press 902, hard press 904, press and hold 906, and double tap 908 may each be mapped to a particular transaction. This mapping may be configured for board games, the office, web browsing (as discussed herein) and VIM.

For example, in the board game configuration 910, a soft press 902 may cause a move left and move down depending on whether the press is on the left or right of the device, a hard press 904 a move down and move up, while a press and hold 906 may cause cancel and select. As would be understood, the left and right of the device as well as the center of the device can be used. Further, delineation may also be achieved as between left, right and center, for example.

For example, in the office configuration 915, a soft press 902 may cause bold and copy, and previous paragraph depending on whether the press is on the left or right of the device, a hard press 904 italic and paste, and next paragraph, while a press and hold 906 may cause undo and cut.

For example, in the web browsing configuration 920, a soft press 902 may cause page down and next link, a hard press 904 page up and next tab, while a press and hold 906 may cause back a page and follow link, depending on whether the action is on the left or right of the device.

In the VIM configuration 925, a soft press 902 may cause previous window and next window, a hard press 904 previous screen and next screen, while a press and hold 906 may cause discard quit and save quit, depending on whether the action is on the left or right of the device.

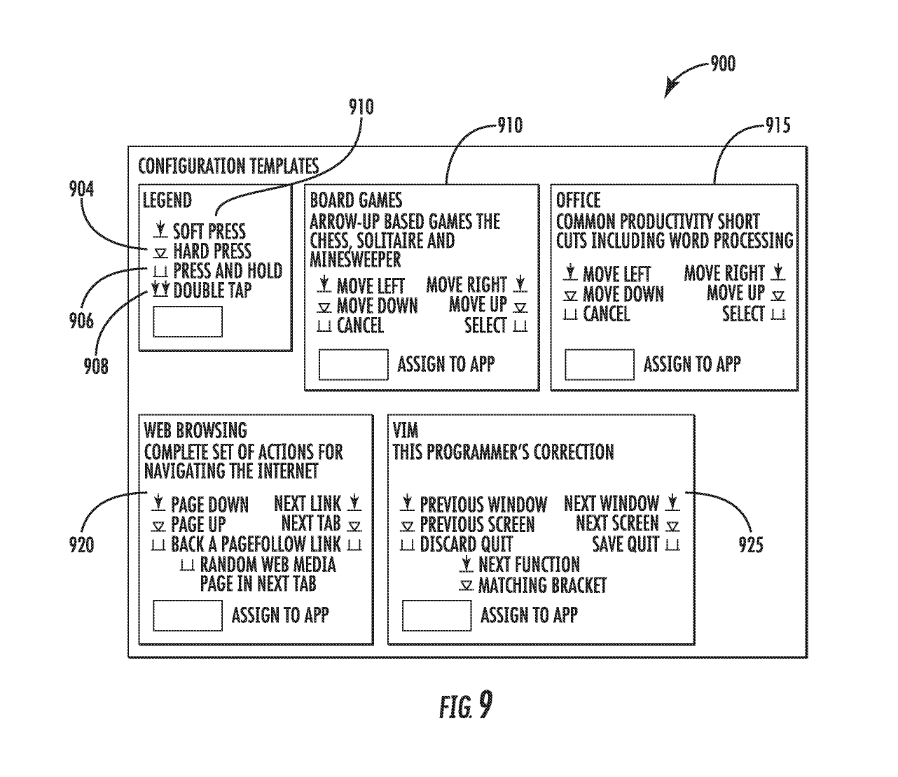

The input device may take a myriad of different forms. FIGS. 10-15 provide several example input devices. FIG. 10 illustrates a basic design of an input device. Input device 1000 includes a wedged surface 1010 over a base 1020. Base 1020 may provide stability on the surface for which the input device sits. Base 1020 may be designed to prevent movement along the surface on which input device 1000 sits. Motion and activation of wedged surface 1010 compared to base 1020 may be measured by internal electronics (not shown in this figure but additional detail provide with respect to other input device designs).

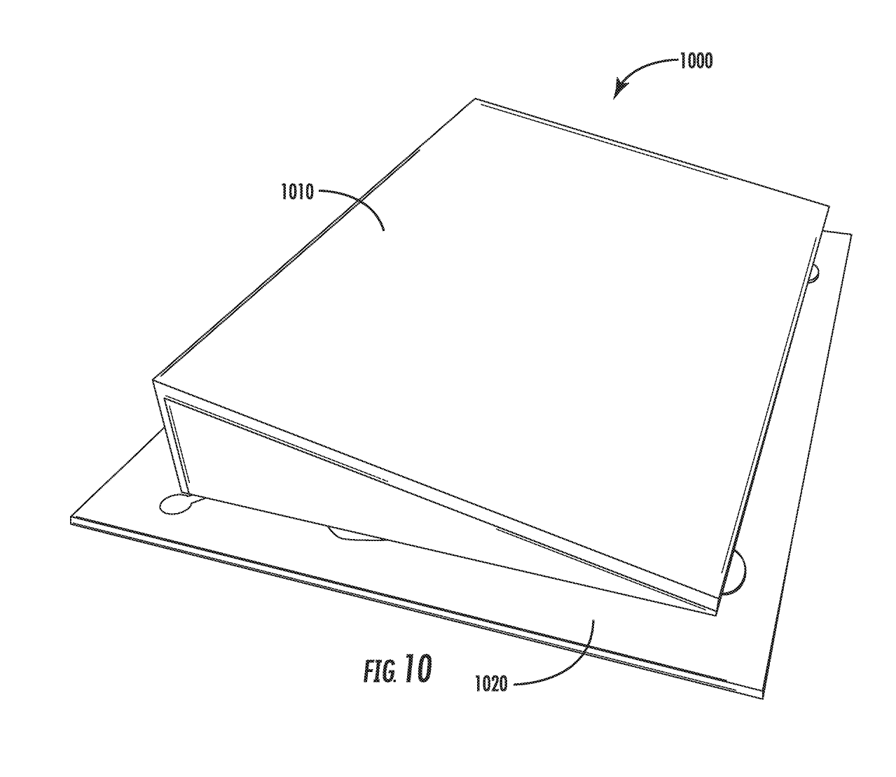

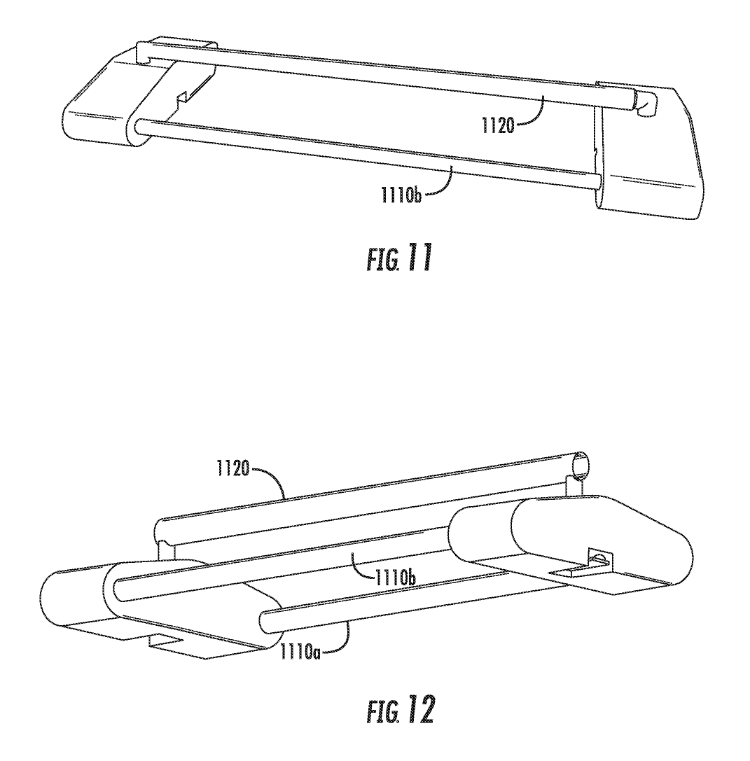

As depicted in several of these examples illustrated in FIGS. 11 and 12, two rods 1110a, b serve as the base for a device placed at a user's feet, with a third centrally mounted rod 1120 mechanically coupled to a force sensitive resistor(s). The connecting end pieces may be injection molded plastic, wood, or machined metal in construction, and may contain the processing electronics within. The sensor is configured such that when a user presses on any location of the center rod, force is transferred to two sensors mounted at each end of the device, such that the position of user input can be inferred by the combination of inputs.

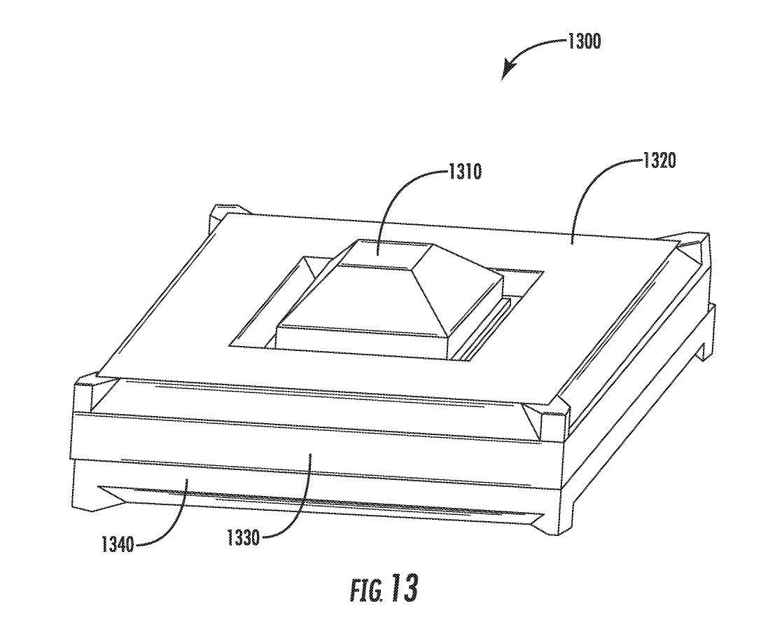

FIG. 13 illustrates an embodiment 1300 of the user input device. Device 1300 includes a pressure sensitive portion 1310 to receive input from a user. A top housing 1320 may protect the insides of device 1300. An interface layer 1330 may be used to mechanically transfer the input to pressure sensitive portion 1310 to internal electronics (not shown). A bottom housing 1340 the insides of device 1300.

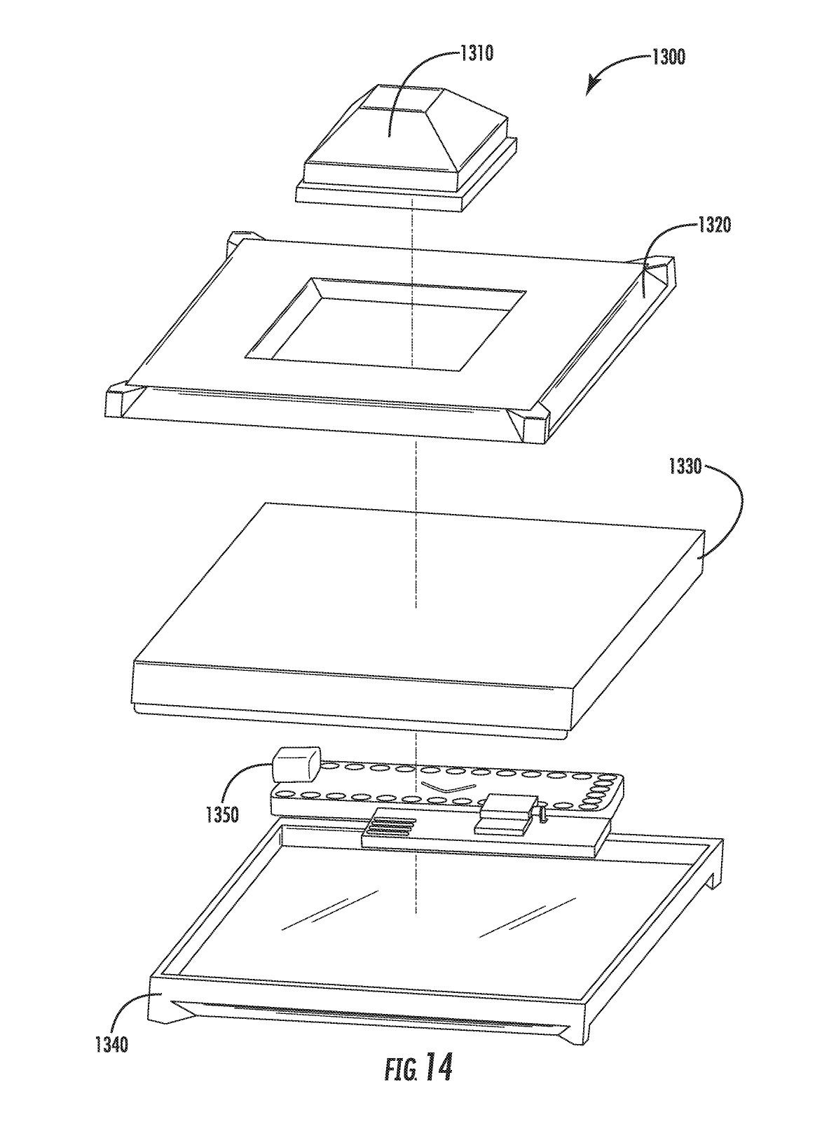

Referring now also to FIG. 14, device 1300 is shown in an exploded view. Pressure sensitive portion 1310, top housing 1320, bottom housing 1340 are shown in exploded view. Interface layer 1330 is shown in additional detail. In addition, an internal electronics layers 1350 is shown. This layer includes electronics to receive the inputs from pressure sensitive portion 1310 via interface layer 1330, and electronically translate the mechanical inputs in to signals (as described below) that can then be later translated to computing device inputs.

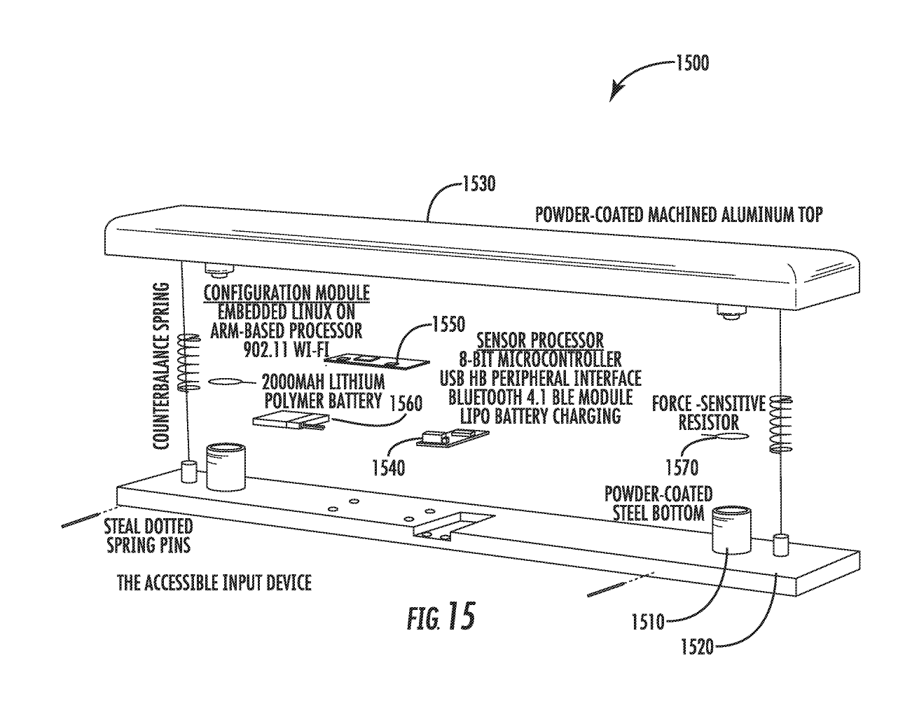

FIG. 15 illustrates an alternative configuration 1500 for the user input device. Device 1500 may include sensors 1510 housed in an all-metal machined enclosure including a top 1520 and bottom housing 1530. The enclosure may include the sensor processor 1540, configuration module 1550, battery 1560 and supporting electronics 1570 (illustrated as force sensitive resistor, although one would understand other electronics are involved and are not shown). The machined pieces of the input device 1520, 1530 may be powder-coated aluminum with guides and springs. The force sensitive resistor 1570 may be place on the left/right between a top piece 1530 and a bottom piece 1520. The sensor processor 1540 may be house within the input device 1500, by way of example. The input device 1500 may also include powering devices such as a battery pack 1560, for example. A configuration module 1550 discussed herein may also be included within the input device 1500.

Generally, each design of the input device includes a flex sensor may be utilized to detect inputs. A flex sensor is a film-type device which varies in impedance based on amount of pressure applied (“force sensitive resistor”). The device itself varies continuously, from a very high impedance (greater than 1 mega ohm) when under no pressure, to a low impedance (<100 ohm) when strong pressure is applied over the full surface. The sensors may be connected in a voltage divider with a fixed resistor, with the applied pressure being read on one of the microcontroller's analog to digital converter inputs. Three force-sensitive resistors may be employed as potentiometers in the voltage divider offering many combinations. Four force-resistors may also be used to provide additional combinations.

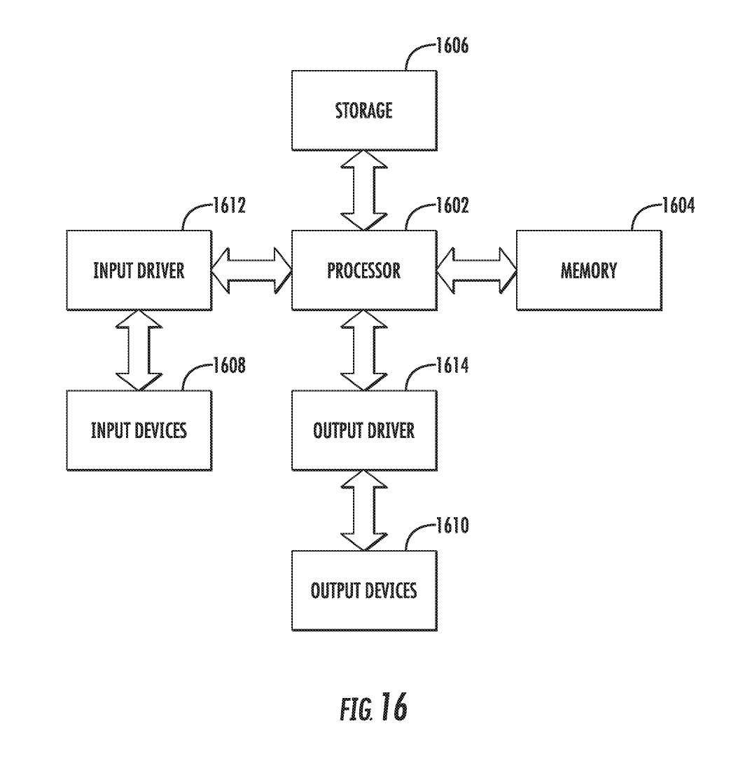

FIG. 16 is a block diagram of an example device 1600 in which one or more features of the disclosure can be implemented. The device 1600 can include, for example, a computer, a gaming device, a handheld device, a set-top box, a television, a mobile phone, or a tablet computer. The device 1600 includes a processor 1602, a memory 1604, a storage 1606, one or more input devices 1608, and one or more output devices 1610. The device 1600 can also optionally include an input driver 1612 and an output driver 1614. It is understood that the device 1600 can include additional components not shown in FIG. 16.

In various alternatives, the processor 1602 includes a central processing unit (CPU), a graphics processing unit (GPU), a CPU and GPU located on the same die, or one or more processor cores, wherein each processor core can be a CPU or a GPU. In various alternatives, the memory 1604 is be located on the same die as the processor 1602, or is located separately from the processor 1602. The memory 1604 includes a volatile or non-volatile memory, for example, random access memory (RAM), dynamic RAM, or a cache.

The storage 1606 includes a fixed or removable storage, for example, a hard disk drive, a solid state drive, an optical disk, or a flash drive. The input devices 1608 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 1610 include, without limitation, a display, a speaker, a printer, a haptic feedback device, one or more lights, an antenna, or a network connection (e.g., a wireless local area network card for transmission and/or reception of wireless IEEE 802 signals).

The input driver 1612 communicates with the processor 1602 and the input devices 1608, and permits the processor 1602 to receive input from the input devices 1608. The output driver 1614 communicates with the processor 1602 and the output devices 1610, and permits the processor 1602 to send output to the output devices 1610. It is noted that the input driver 1612 and the output driver 1614 are optional components, and that the device 1600 will operate in the same manner if the input driver 1612 and the output driver 1614 are not present. The output driver 1614 is configured to accept compute commands and graphics rendering commands from processor 1602, to process those compute and graphics rendering commands, and to provide pixel output to display device for display.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system for using a computing device that translates inputs from a user input device into inputs to the computing device, the system comprising:
one or more electronic sensors for detecting inputs from a user;
a central processing unit;
a data acquisition system coupled to the central processing unit, capable of collecting data from the one or more electronic sensors; and
an interface of the central processing unit, capable of transmitting keyboard or mouse input signals to an attached computer, wherein processed inputs are translated into key presses, mouse movement, and/or mouse presses to perform a desired action on the attached computer.

2. The system of claim 1, wherein the electronic sensors provide a plurality of inputs such as level of pressure or angle of tilt.

3. The system of claim 1, wherein the central processing unit holds software or firmware which performs the functions of the system.

4. The system of claim 1, wherein said data acquisition collects analog signals from sensors and converts them to discrete digital values.

5. The system of claim 1, wherein sensor inputs are processed in a manner that distinguishes discrete user inputs into an interpretable signal.

6. The system of claim 1, wherein the interface is either Universal Serial Bus or Bluetooth.

7. The system of claim 1, wherein the interpretable signal includes at least one of duration of input, amount of pressure, location of pressure, angle of tilt and angular velocity.

8. The system of claim 1, wherein the processed inputs are temporally combined and interpreted as a single input from a user.

9. The system of claim 1, wherein a user-provided sequence of keyboard or mouse inputs are transmitted to an attached device.

10. The system of claim 1, wherein desired actions are defined by a user.

11. A method for using a computing device that translates inputs from a user input device into inputs to the computing device, the method comprising:
detecting inputs from a user using one or more electronic sensors;
collecting data from the one or more electronic sensors using a data acquisition system coupled to the central processing unit;
translating collected data into input signals to perform desired computing device action; and
transmitting keyboard or mouse input signals to an attached computer.

12. The method of claim 11, wherein the electronic sensors provide a plurality of inputs such as level of pressure or angle of tilt.

13. The method of claim 11, wherein the central processing unit holds software or firmware which performs the functions of the system.

14. The method of claim 11, wherein said data acquisition collects analog signals from sensors and converts them to discrete digital values.

15. The method of claim 11, wherein sensor inputs are processed in a manner that distinguishes discrete user inputs into an interpretable signal.

16. The method of claim 11, wherein the interface is either Universal Serial Bus or Bluetooth.

17. The method of claim 11, wherein the interpretable signal includes at least one of duration of input, amount of pressure, location of pressure, angle of tilt and angular velocity.

18. The method of claim 11, wherein the processed inputs are temporally combined and interpreted as a single input from a user.

19. The method of claim 11, wherein a user-provided sequence of keyboard or mouse inputs are transmitted to an attached device.

20. The method of claim 11, wherein desired actions are defined by a user.
